(19) United States
(12) Patent Application Publication
(10) Pub. No.: US 2018/0035726 A1
(43) Pub. Date: Feb. 8, 2018

(54) GARMENT WITH WIRELESS ENTRY DEVICE

(71) Applicants: Matthew James Harkins, Carlsbad, CA (US); Richard Whitlock, Carlsbad, CA (US)

(72) Inventors: Matthew James Harkins, Carlsbad, CA (US); Richard Whitlock, Carlsbad, CA (US)

(21) Appl. No.: 15/227,155

(22) Filed: Aug. 3, 2016

(51) Int. Cl. A41D 1/00; B60R 25/24; A41D 1/06; G07C 9/00; B63C 11/04; A41D 27/20; A41D 31/00; A41D 7/00; B60R 25/20; A43B 3/00

(52) U.S. Cl. CPC A41D 1/002; B60R 25/209; B60R 25/245; B60R 25/24; A41D 1/06; A43B 3/0005; B63C 11/04; A41D 27/208; A41D 31/00; A41D 7/005; G07C 9/00309; B60R 2325/205; B60R 2325/101; B60R 2325/103; B60R 2325/105; B63C 2011/046; G07C 2009/00769

(57) ABSTRACT

A wearable entry device (WED) is disclosed that may be integrated into a garment. The WED may be used to lock and unlock a vehicle door. In one example, surfing board shorts may include a WED.

### BACKGROUND OF THE INVENTION

### 1. Field of the Invention

This present invention relates to articles of clothing, shoes, and other wearable apparel. More particularly, the present invention relates to articles of clothing, shoes, and other wearable apparel that include a wireless entry device (WED), such as a keyless entry device for unlocking or locking a lock of a vehicle or other similar apparatus. The WED may also have other functionality including interaction with a mobile device running an application, using wireless networking or Bluetooth, and/or a hotel room/door opener.

### 2. Background

Many sports require that the participant engage in the sporting activity outside in places where supervision and the ability to store accessories, such as keys, phones, wallets, etc. are virtually non-existent, unreasonable, unsafe, or illegal. For example, a surfer, swimmer, diver, boatman or similar watersport participant typically places the key under the bumper of a car, thereby exposing himself or herself vehicle theft. Some wetsuits and water sports equipment have loops or clips to attach keys, but as cars become more modern, most car keys are electronic and are not waterproof and too bulky to be practically worn on the body. In some cases, participants have experienced the unfortunate situation of being left with no wallet, identification, or even having their vehicle stolen. It is also possible to store-accessories in a dry bag or other storage device and bury the bag in the sand or hide it somewhere where it cannot be found on or in a car. This exposes the surfer to theft and being stranded, especially in remote areas, if the bag or other storage device is confiscated.

Alternatively, the surfer may hide an accessory somewhere in an article of clothing. However, most of the time the surfer is paddling the board to catch a wave is wearing only a bathing suit and/or a pair of board shorts or wet suits, which are required when the weather and/or water temperature is cooler. This means that the key may become cumbersome, reduce performance, and create discomfort for the surfer. Additionally, keys are easily lost in the water and very likely not recoverable.

Accordingly, there is a need for a method, system, and apparatus for wireless entry that avoids the need to carry or hide accessories.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIGS. 1A-1C illustrate an example of an article of clothing in an embodiment with a WED.

FIG. 2 illustrates an example of an article of clothing in an embodiment.

FIG. 3 illustrates an example WED communicating wirelessly with a car.

FIG. 4 illustrates a WED in an embodiment.

FIGS. 5-7 illustrate a WED in other exemplary embodiments.

FIG. 8 illustrates a method in an embodiment.

### SUMMARY

In one aspect, there is disclosed a garment that includes a wireless entry device (WED) integrated therein, where the WED in wireless communication with and configured to unlock and lock a door of a vehicle.

In one aspect, there is disclosed a garment that includes a wireless entry device (WED) integrated therein, where the WED in wireless communication with an object.

The garment may be configured for one of setting off a panic alarm, starting a vehicle, starting a timer, turning on/off lights, and to interface with an application on a mobile device. The WED may communicate with the vehicle using one of Wi-Fi. Bluetooth, and RFID protocols.

The WED may comprise an unlock button, a lock button 42, a RF Unit, a keyless access module, an antenna, and a battery. The garment may include a waterproof material, and also may include board shorts, a wetsuit, headwear, footwear, pants, or a bag. The WED may be welded, stitched, or sonically welded into the garment. The garment may include a removable pocket, and the pocket may be waterproof. The WED may communicates with the vehicle at a distance of approximately five feet or less.

### DETAILED DESCRIPTION

Each of the additional features and teachings disclosed below can be utilized separately or in conjunction with other features and teachings to provide a device, system, and/or method for an article of clothing with a wireless entry device (WED). Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Devices, methods, and systems are described for an article of clothing, garments, shoes, or apparel that include a wireless entry device (WED). It should be noted that references to terms clothing, garment, and apparel are meant to refer to an item that is wearable on one or more parts of the body. It will be understood that embodiments are not limited to any particular style or type of garment. Also, any type of outdoor activity or athletic training technique may be conducted in the garment. In one embodiment, the WED may be integrated into the garment and may wirelessly communicate with one or more objects or devices, such as a vehicle, a bike, a door, or other object. Any number of different wireless technologies and topologies may be used including RFID. Bluetooth, Wi-Fi. In one embodiment, one or more of the components of the WED may be waterproof. The WED may include one or more buttons that may be used for certain functionality, such as locking and unlocking a door, setting off a panic alarm, starting a vehicle, starting a timer, turning on/off lights, and to interface with application on a mobile device.

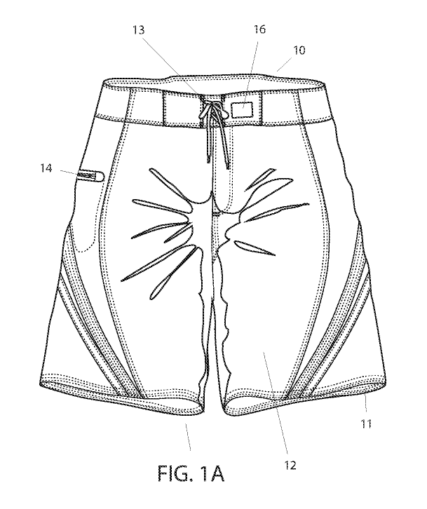

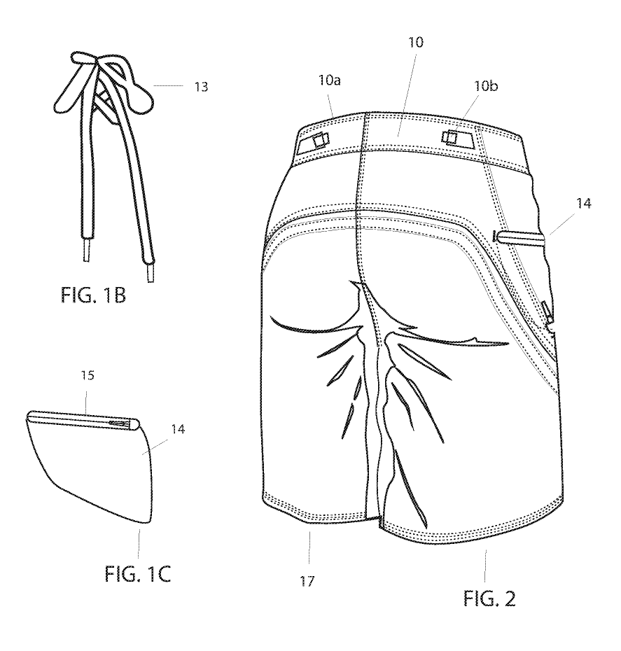

FIG. 1A shows a garment 10 in an embodiment. It should be noted that garment 10 as shows is a pair of surf or board shorts. Garment 10 may also include a type of shoe, wetsuit, apparel, headwear, footwear, or bag. As shown in FIG. 1A, the garment 10 may include a front side 12, seams 11, a waterproof and removable pocket 14, and a WED 16. The garment 10 may be adjusted along the waist by a drawstring 13 in an embodiment. The garment 10 may also include other adjusting devices. The garment 10 may be formed from any type of material for use in athletic activity, such as woven and non-woven knits, spandex, Lycra, and athletic mesh.

Referring again to FIG. 1A, the seams 11 may be welded or stitched. The WED 16 may be stitched or sonically welded into the garment 10 in an embodiment. Other types of methods may include Velcro or glue.

The WED 16 may be placed or integrated anywhere in garment 10. The WED may have any size such that it fits comfortably in the garment 10. FIG. 1B illustrates the drawstring 13 in an embodiment. FIG. 1C illustrates the pocket 14 in an embodiment. The pocket 14 may be waterproof and include an opening 15, which may include buttons, zippers, snaps, and Velcro. VELCRO. The pocket 14 may have any size suitable for a particular garment 10. In one embodiment, the pocket 14 may be configured to receive a credit card, license, mobile device, passport, hotel key, key, cash, and coins.

FIG. 2 shows a rear view of the garment 10 having a rear side 17. The garment 10 may have a quick draw waist 18A, 18B. In some embodiments, the pocket 14 may be integrated into the garment in any way suitable for comfort.

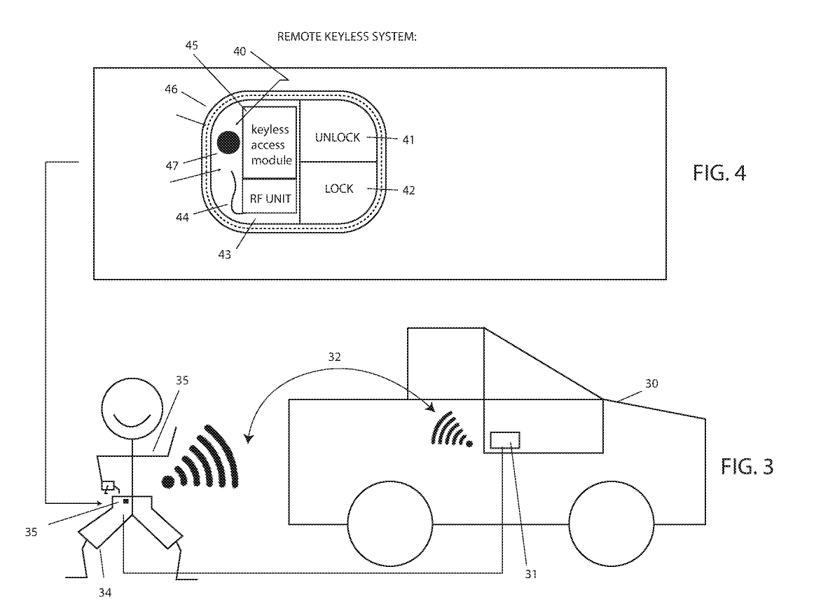

FIG. 3 shows a WED 33 configured in a garment 34 being worn by a person 35. The WED 33 is substantially the same as WED 16 and garment 34 is substantially the same as garment 10. The WED 33 may communicate wirelessly with a circuit 32 that is configured to unlock and lock door 31 of vehicle 30. The WED 33 may communicate using RF technology or Bluetooth. In one embodiment, the WED 33 may communicate with circuit 32 about five feet apart. Other distances are also possible.

FIG. 4 illustrates a WED 40 in an embodiment that includes a housing 46 that is made from molded rubber, TPU, metal or plastic. In one embodiment, the WED 40 is a remote keyless device for opening a door of a vehicle. The WED 40 is substantially the same as WED 16, 33. The WED 40 may include an unlock button 41, lock button 42, RF Unit 43, keyless access module 45, an antenna 44, and a battery 47. The WED 40 may be stitched or sonic welded into garment 10. The module 45 may include software or hardware or some combination thereof to synchronize with an encryption of a vehicle door lock, store a door lock/unlock code, erase stored codes, reset one or more functions, and/or a start/stop panic button or alarm.

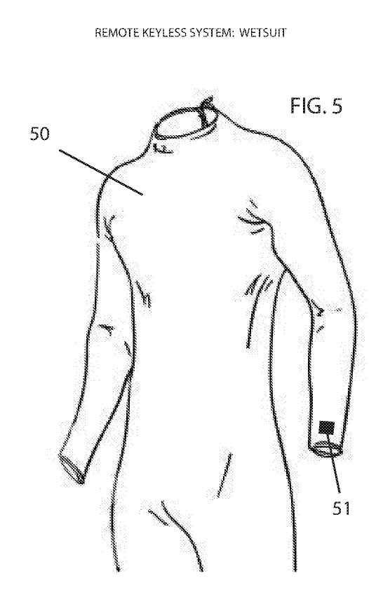

FIG. 5 shows a WED 51 in the arm of a wetsuit 50. The WED 51 may be substantially the same as the WED 33. The WED 51 may be integrated into other parts of the wetsuit 50.

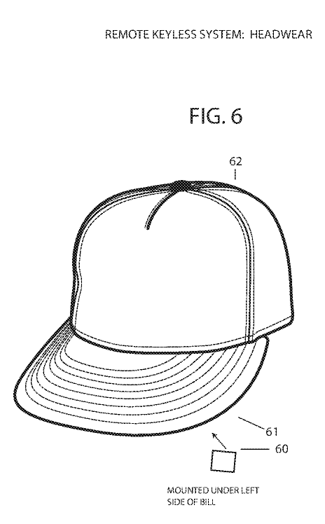

FIG. 6 illustrates a WED 60 attached or integrated into the underside 61 of a hat 60. The WED 60 may substantially the same as WED 33. The WED 60 may be integrated in other parts of the hat 62.

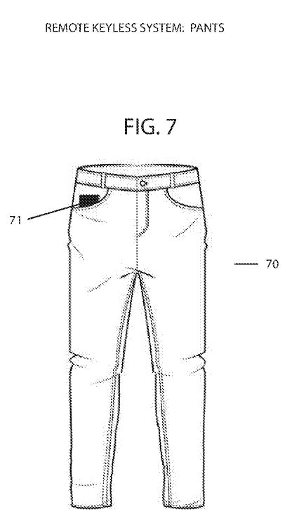

FIG. 7 shows a pair of pants 70 with a WED 71 that may be attached to, integrated in, or replace a pocket of the pants 70. The pants 70 may also include a waterproof pocket. The WED 71 may be substantially the same as the WED 33.

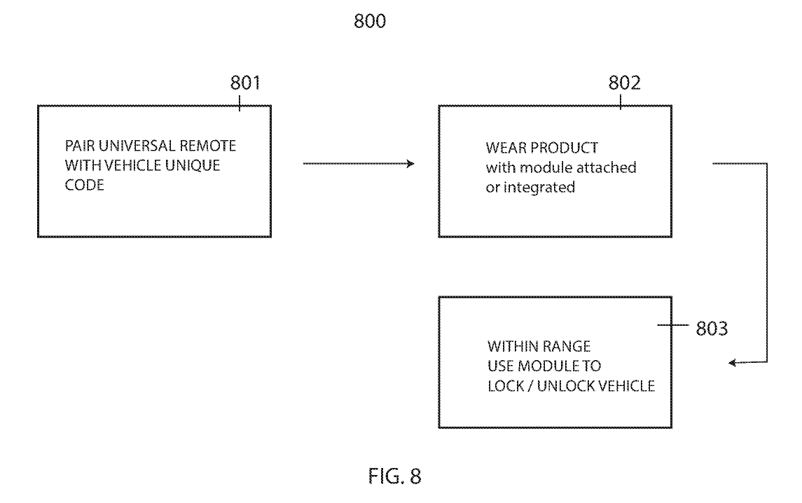

FIG. 8 shows a flow diagram of a method 800 in an embodiment. In step 801, the WED is paired with a vehicle in an embodiment, such that the WED may open and close a vehicle door. In step 802, the WED may be removably attached, previously integrated or attached, or in a like manner to a garment and worn. In step 803, the WED may be used to lock or unlock the vehicle.

The present invention or any part(s) or function(s) thereof, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A garment, comprising:
a wireless entry device (WED) embedded in the garment to form a single combined article with the garment that is not removable once embedded, the WED in wireless communication with and configured to unlock and lock a door of a vehicle.

2. The garment of claim 1, wherein the WED is configured for one of setting off a panic alarm, starting a vehicle, starting a timer, turning on/off lights, and to interface with application on a mobile device.

3. The garment of claim 1, wherein the WED communicates with the vehicle using one of Wi-Fi, Bluetooth, and RFID protocols.

4. The garment of claim 1, wherein the WED comprises an unlock button, a lock button, a RF Unit, a keyless access module, an antenna, and a battery.

5. The garment of claim 1 further comprising a waterproof material.

6. The garment of claim 1 further comprising one of board shorts, a wetsuit, headwear, footwear, pants, and a bag.

7. The garment of claim 1, wherein the WED is one of welded, stitched, and sonically welded into the garment.

8. The garment of claim 1 further comprising a removable pocket.

9. The garment of claim 8, wherein the pocket is waterproof.

10. The garment of claim 1, wherein the WED communicates with the vehicle at a distance of approximately five feet or less.

11. A garment, comprising:
a wireless entry device (WED) formed into the garment to form a single combined article with the garment that is not removable once formed, the WED in wireless communication with an object.

12. The garment of claim 11, wherein the WED is configured for one of setting off a panic alarm, starting a vehicle, starting a timer, turning on/off lights, and to interface with an application on a mobile device.

13. The garment of claim 11, wherein the WED communicates with the object using one of Wi-Fi, Bluetooth, and RFID protocols.

14. The garment of claim 11, wherein the WED comprises an unlock button, a lock button, a RF Unit, a keyless access module, an antenna, and a battery.

15. The garment of claim 11 further comprising a waterproof material.

16. The garment of claim 11 further comprising one of board shorts, a wetsuit, headwear, footwear, pants, and a bag.

17. The garment of claim 11, wherein the WED is one of welded, stitched, and sonically welded into the garment.

18. The garment of claim 11 further comprising a removable pocket.

19. The garment of claim 18, wherein the pocket is waterproof.

20. The garment of claim 11, wherein the WED communicates with the vehicle at a distance of approximately five feet or less.
